(19) United States
(12) Patent Application Publication
(10) Pub. No.: US 2025/0278046 A1
(43) Pub. Date: Sep. 4, 2025

(54) PRINTING SYSTEM THAT RELIABLY SAVES LOG OF FIRMWARE WHEN JAM OCCURS, METHOD OF CONTROLLING PRINTING SYSTEM, AND STORAGE MEDIUM

(71) Applicant: CANON KABUSHIKI KAISHA, Tokyo (JP)

(72) Inventor: SHINICHI KANEMATSU, Chiba (JP)

(21) Appl. No.: 19/066,768

(22) Filed: Feb. 28, 2025

(30) Foreign Application Priority Data
Mar. 4, 2024 (JP) 2024-031994

(51) Int. Cl. G03G 15/00; G03G 15/22; G06F 3/12

(52) U.S. Cl. CPC G03G 15/5012; G03G 15/228; G03G 15/502; G03G 15/5075; G03G 15/70; G06F 3/121; G06F 3/1234

(57) ABSTRACT

A printing system including a jam detection section that detects occurrence of a jam as a state in which a sheet is jammed, a guide display section that displays a guide of a procedure for removing a sheet in response to occurrence of the detected jam, and a plurality of units associated with a plurality of types of functions, respectively. An operation log of firmware that controls one unit is automatically saved. A setting of whether or not to automatically save a log when a jam has occurred is displayed. When occurrence of a jam is detected in a case where the automatic log saving is set, a controller causes a process for automatically saving an operation log of firmware to be executed, and a screen to be displayed on a display section for prompting a user to wait until the automatic saving process is terminated.

### BACKGROUND OF THE INVENTION

### Field of the Invention

The present invention relates to a printing system that reliably saves a log of firmware when a jam has occurred, a method of controlling the printing system, and a storage medium.

### Description of the Related Art

In a printing apparatus that prints an image on a recording medium, such as paper, and outputs the printed recording medium, a paper jam (hereinafter referred to as “a jam”) sometimes occurs. When a jam has occurred, a user is required to take measures for recovering the printing apparatus to a state in which the print operation can be restarted, by eliminating e.g. a sheet, which has been jammed (jammed sheet), by a manual operation. To this end, when a jam has occurred, the printing apparatus notifies the user of occurrence of the jam by using a display screen of a console section of the printing apparatus, an error lamp, or the like. Accordingly, there has been provided a printing apparatus that performs notification to the user, by displaying, on a display screen of a console section, a position of the jammed sheet and a procedure for opening an apparatus cover so as to enable the user to easily access the jammed sheet, a procedure for removing and attaching a unit, and so forth, thereby guiding resolving of the jam.

Further, in the printing apparatus, conveyance of a sheet, an image formation operation, and so forth are controlled by respective firmware items for units as components of the apparatus, and a jam can be caused by a malfunction of the firmware. To overcome this inconvenience, there has been disclosed a technique of automatically saving an operation log of firmware in a nonvolatile memory upon occurrence of an error in a printing apparatus, so as to enable a vendor of the apparatus to investigate the problem of the firmware (see e.g. Japanese Laid-Open Patent Publication (Kokai) No. 2019-118056).

However, it sometimes takes time to save an operation log of the firmware, and hence this can cause a case where if a user performs a power-on/off operation of the printing apparatus during the processing for saving the log, acquisition of the log is uncompleted. Further, parallel execution of the processing for saving the operation log, the processing for resolving the jam, and the job operation restarted after the resolving of the jam results in an increase of the load on the control of the printing apparatus, and this can further cause a malfunction.

### SUMMARY OF THE INVENTION

The present invention provides a printing system that reliably saves a log of firmware when a jam has occurred and enables a user to grasp the fact, a control method, and a storage medium.

In a first aspect of the present invention, there is provided a printing system including a jam detection section that detects occurrence of a jam as a state in which a sheet is jammed, a guide display section that displays a guide of a procedure for removing a sheet in response to occurrence of the detected jam, and a plurality of units associated with a plurality of types of functions, respectively, including a log saving section that automatically saves an operation log of firmware that controls one unit, a log saving priority-setting section for setting a priority of operation of the log saving section when a jam has occurred, and a controller that causes, when occurrence of a jam is detected by the jam detection section in a case where the priority of operation of the log saving section has been set by the log saving priority-setting section, the log saving section to execute an automatic saving process for automatically saving an operation log of firmware, and a screen to be displayed on a display section, for prompting a user to wait until the automatic saving process is terminated.

In a second aspect of the present invention, there is provided a method of controlling a printing system including a jam detection section that detects occurrence of a jam as a state in which a sheet is jammed, a guide display section that displays a guide of a procedure for removing a sheet in response to occurrence of the detected jam, and a plurality of units associated with a plurality of types of functions, respectively, including automatically saving an operation log of firmware that controls one unit, setting a priority of saving the operation log when a jam has occurred, and causing, when occurrence of a jam is detected by the jam detection section in a case where the priority of saving the operation log has been set, an automatic saving process to be executed for automatically saving an operation log of firmware, and a screen to be displayed on a display section, for prompting a user to wait until the automatic saving process is terminated.

According to the present invention, it is possible to reliably save a log of firmware when a jam has occurred, and a user can grasp this fact.

Further features of the present invention will become apparent from the following description of exemplary embodiments (with reference to the attached drawings).

### BRIEF DESCRIPTION OF THE DRAWINGS

FIG. 1 is a configuration diagram of a system according to embodiments of the present invention.

FIG. 2 is a main internal configuration diagram of a printing system.

FIG. 3 is a schematic explanatory view of a configuration of the printing system.

FIG. 4 is an explanatory diagram of a console section included in the printing system.

FIG. 5 is an explanatory diagram of a jam processing screen displayed when a jam has occurred.

FIG. 6 is an explanatory diagram of a setting screen of a log saving priority mode.

FIG. 7 is an explanatory diagram of screen display in the log saving priority mode.

FIG. 8 is an explanatory diagram of a configuration of saved logs.

FIG. 9 is a flowchart of a process including a log saving process when a jam has occurred.

FIG. 10 is a flowchart of an automatic log saving process.

FIG. 11 is a sequence diagram in a first embodiment.

FIG. 12 is an explanatory diagram of an example of a table defining jam codes and log saving targets.

FIG. 13 is an explanatory diagram of an example of screen display in the log saving priority mode in a second embodiment.

FIG. 14 is a sequence diagram in the second embodiment.

### DESCRIPTION OF THE EMBODIMENTS

The present invention will now be described in detail below with reference to the accompanying drawings showing embodiments thereof. The embodiments of the present invention will be described below with reference to the drawings. However, the configuration described in the following embodiments is given only by way of example, and is by no means intended to limit the scope of the present invention. First, a first embodiment of the present invention will be described.

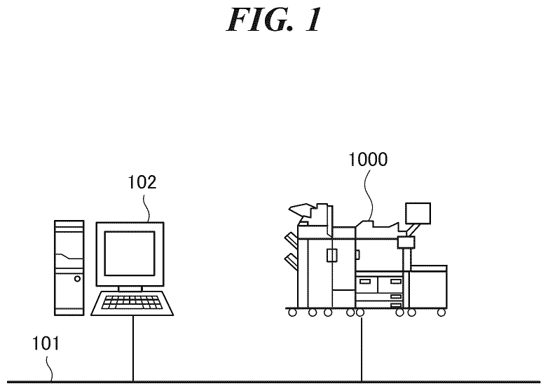

As shown in FIG. 1, the present system includes a printing system 1000 and a client computer 102 (hereinafter referred to as the PC 102), and these are connected to each other via a network 101 in a state capable of communicating necessary information between them. Further, the PC 102 is enabled to transmit a page description language (PDL) code data which is a print job to the printing system 1000 via the network 101.

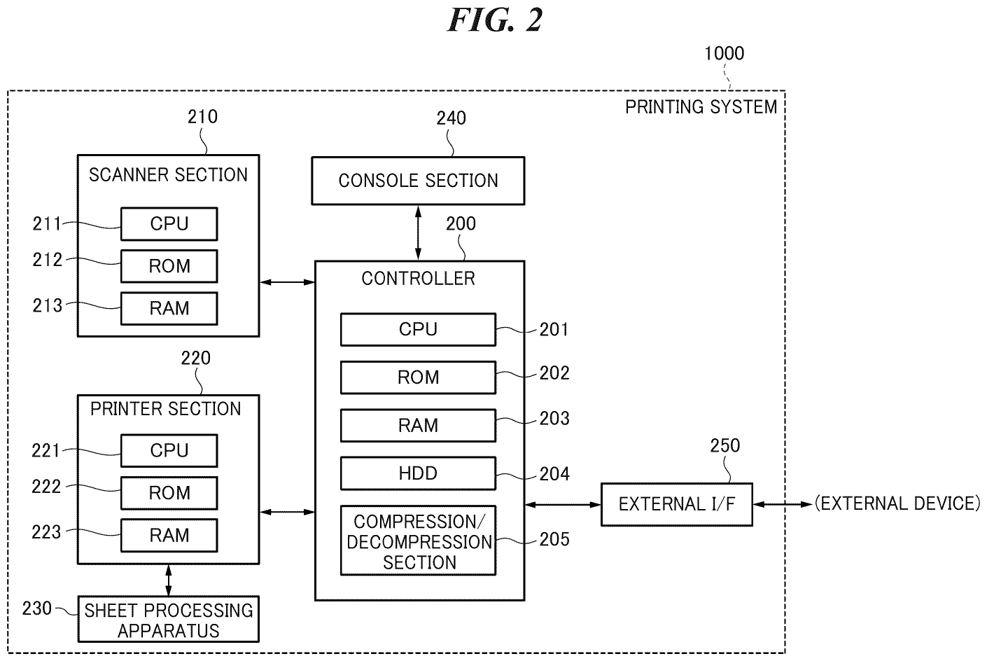

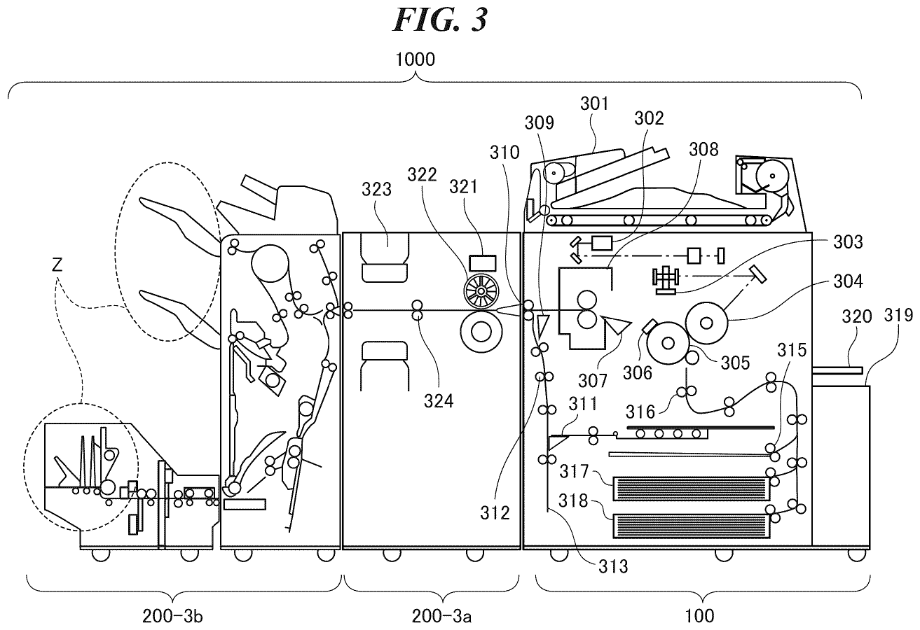

As shown in FIG. 3, described hereinafter, the printing system 1000 includes a printing apparatus 100, a charge elimination apparatus 200-3a, and a saddle-stitch binding machine 200-3b. In the present embodiment, a main unit that performs image formation is the printing apparatus 100, and the printing system 1000 is formed by further adding, to the printing apparatus 100, components including a post-processing apparatus that performs post processing on a sheet discharged from the printing apparatus 100. Besides, FIG. 2 shows main components, such as a scanner section 210, a printer section 220, and a controller 200, which are included in the printing system 1000. Further, the printing system 1000 can connect a desired number of sheet processing apparatuses 230. Further, in the present embodiment, an Multi-Function Peripheral (MFP) having a plurality of functions, such as a copy function and a printer function, will be described as an example of the printing system 1000. However, the printing system 1000 can be a single-function printing apparatus having only the copy function or the printer function. Note that in the present embodiment, the printing system 1000 is assumed, by way of example, to be equipped with a variety of component elements described below.

The printing system 1000 is configured to be capable of executing sheet processing on a sheet printed by the printer section 220, by using the sheet processing apparatus 230. However, the printing system 1000 can be configured without connecting the sheet processing apparatus 230. The sheet processing apparatus 230 is communicably connected to the printer section 220 and is capable of executing sheet processing upon receipt of an instruction from the printer section 220. The scanner section 210 reads an image on an original, converts the read image into image data, and transfers the image data to another unit. The scanner section 210 has a read only memory (ROM) 212 storing a firmware program for executing and controlling the scan operation, a central processing unit (CPU) 211 that reads out the firmware from the ROM 212 and executes the firmware, and a random access memory (RAM) 213. The RAM 213 temporarily stores e.g. data during execution of the firmware. Further, an external interface (I/F) 250 is an interface for transmitting and receiving data to and from another apparatus (external device) connected to the network 101.

The printer section 220 prints an image on a sheet as a printing medium based on input image data. The printer section 220 has a ROM 222 storing a firmware program, a CPU 221 that reads out the firmware from the ROM 222 and executes the firmware, and a RAM 223. The RAM 223 temporarily stores e.g. data during execution of the firmware. The scanner section 210 and the printer section 220 are each configured to form part of a RAM area associated therewith as a ring buffer in association with the operation thereof and output an old operation log while storing a new operation log.

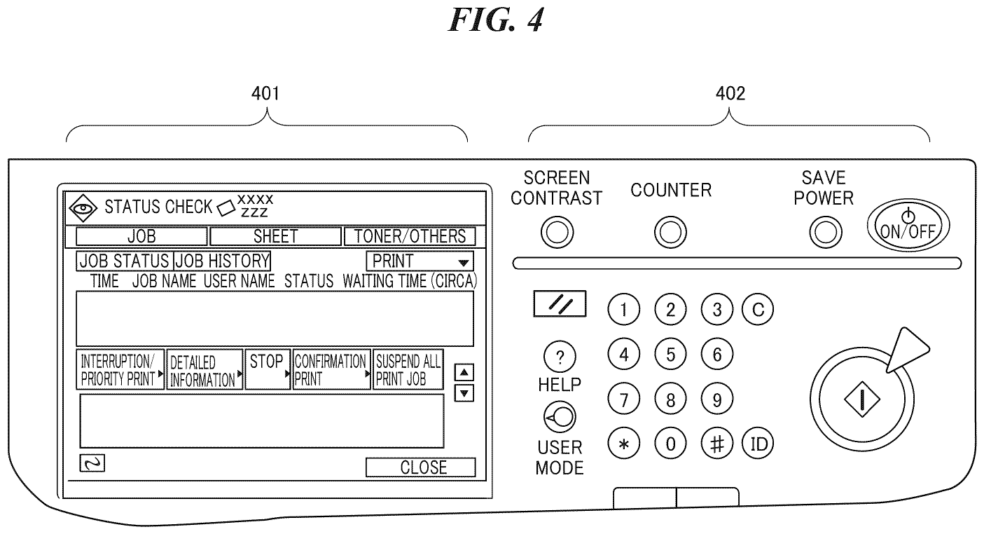

A console section 240 has such a configuration as shown in FIG. 4. The console section 240 has a touch panel section 401 and a hard key input section (key input section) 402 by way of example, and when a user operates these components, the console section 240 receives an instruction from the user. Further, the console section 240 performs a variety of displays for the touch panel section 401. For example, when the user performs input using any of numeric keys and a variety of keys of the hard key input section 402, the console section 240 grasps a key operated for input. Further, the console section 240 grasps a character, a command, and so forth, input by a touch operation of the user.

The controller 200 connected to the console section 240 has a CPU 201, a ROM 202, a RAM 203, a hard disk drive (HDD) 204, and a compression/decompression section 205. The CPU 201 of the controller 200 performs centralized control of processes and operations, performed by a variety of units included in the printing system 1000. That is, the controller 200 controls the scanner 210, the printer section 220, the console section 240, the external I/F 250, and so forth, and functions as a main controller that realizes various functions as the printing system. The CPU 201 of the controller 200 loads a program stored in the ROM 202 into the RAM 203 and executes the loaded program, whereby the variety of processes according to the embodiments of the present invention are realized.

The ROM 202 stores a variety of computer programs executed by the controller 200. The ROM 202 stores programs for causing the controller 200 to execute the processes, described hereinafter, and a display control program necessary to display a variety of setting screens, described hereinafter. Further, the ROM 202 also stores a program for causing the controller 200 to execute an operation of interpreting PDL code data received from the PC 102 and developing the PDL code data into raster image data. Not only these, but the ROM 202 also stores a boot sequence, font information, a threshold value of a charge amount, used for determining a charge elimination effect, described hereinafter, and so forth. The RAM 203 temporarily stores image data and PDL code data, which are transmitted from the scanner section 210 and the external I/F 250, and the variety of programs and setting information, which are loaded from the ROM 202. Further, the RAM 203 stores information concerning the sheet processing apparatus 230 (information concerning a type and a function of the sheet processing apparatus 230).

The controller 200 uses the information concerning the sheet processing apparatus 230, which is stored in the RAM 203, for the control. The HDD 204 is comprised of a drive section that reads and writes data from and into a hard disk. The HDD 204 is a large-capacity nonvolatile storage device for storing image data input e.g. from the scanner section 210 and compressed by the compression/decompression section 205. The controller 200 can execute print processing by passing the image data stored in the HDD 204 to the printer section 220 based on an instruction from a user. Further, the HDD 204 is also used as a spooler, and the controller 200 can manage PDL code data received from the PC 102 as a print job and store this print job in the HDD 204.

That is, the controller 200 is capable of managing the print jobs stored in the HDD 204 and acquiring the number of stored print jobs and a variety of setting information set for each print job. The compression/decompression section 205 performs an operation of compressing/decompressing e.g. image data stored in the RAM 203 and the HDD 204 according to a variety of compression methods, such as JBIG and JPEG. Further, in the present embodiment, the HDD 204 is also used for storing operation logs of the firmware, which have been collected when a jam has occurred. Details of storage of operation logs will be described hereinafter.

Next, the configuration of the printing system 1000 will be described with reference to FIG. 3. FIG. 3 is a cross-sectional view of the printing system 1000 and the sheet processing apparatus 230 connected to this. In FIG. 3, the charge elimination apparatus 200-3a and the saddle-stitch binding machine 200-3b are included as the sheet processing apparatuses.

First, the printing system 1000 will be described. An automatic document feeder (ADF) 301 sequentially separates an original from a bundle of originals, which are set on a stacking surface of an original tray, starting from the first original in a page order, and conveys the original onto an original platen glass to cause a scanner 302 to scan the original. The scanner 302 reads an image on the original conveyed onto the original platen glass and converts the read image into image data by a photoelectric conversion device, such as a CCD. A rotary polygon mirror 303 causes a ray of light, such as laser light, modulated according to the image data to enter, and thereby irradiate the light onto a photosensitive drum 304 as a reflected scanning beam via a reflective mirror.

A latent image formed on the photosensitive drum 304 by the laser beam is developed with toner, and the toner image is transferred onto a sheet affixed on a transfer drum 305. By sequentially executing a series of the image formation process with respect to yellow (Y), magenta (M), cyan (C), and black (K) toner, a full-color image is formed. The sheet on the transfer drum 305, on which the full-color image has been formed after executing the image formation process four times, is separated by a separation claw 306 and conveyed to a fixing device 308 by a pre-fixing conveyer 307.

The fixing device 308 is comprised of a combination of rollers and a belt, and incorporates a heat source, such a halogen heater, to melt and fix the toner on the sheet on which the toner image has been transferred, with heat and pressure. A sheet discharge flapper 309 is formed to be swingable about a swing shaft and defines a conveying direction of a sheet. When the sheet discharge flapper 309 swings in a clockwise direction in FIG. 3, the sheet is straightly conveyed and discharged outside the apparatus by a sheet discharge roller 310. The controller 200 controls the printing system 1000 to execute single-sided printing according to a series of the above-described sequence.

On the other hand, in a case where images are formed on both sides of a sheet, the sheet is sent toward a registration roller 316 again by an inversion flapper 311, an inversion roller 312, an inversion guide 313, and a re-feeding roller 315. In the description of the present embodiment, description of details of sheet conveyance for double-sided printing is omitted. The controller 200 controls the printing system 1000 to execute double-sided printing according to a series of the above-described sequence.

Further, the printing system 1000 has a sheet feeder accommodating sheets necessary for print processing. The sheet feeder has sheet feed cassettes 317 and 318 (for example, each capable of accommodating 500 sheets), a sheet feed deck 319 (for example, capable of accommodating 5000 sheets), a manual feed tray 320, and so forth. In the sheet feed cassettes 317 and 318 and the sheet feed deck 319, a variety of sheets different in size and material can be set for the sheet feeders, respectively.

Further, on the manual feed tray 320, a variety of sheets including a special sheet, such as an OHP sheet, can be set. Information on sheet types of the variety of sheets set in the sheet feeders of the printing system 1000 can be registered in association with the respective sheet feeders from the console section 240 and be stored in the controller 200. Therefore, the controller 200 is configured to be capable of determining, during outputting of a print from the printing system 1000, the registered sheet type information and a sheet type of a sheet on which the print processing is being currently executed.

The charge elimination apparatus 200-3a is an apparatus that prevents adhesion between sheets by eliminating an electric charge on each sheet on which an image has been formed by the printing system 1000 to thereby improve the quality of finishing processing on the sheets. The sheet discharged from the printing apparatus 100 is conveyed to the charge elimination apparatus 200-3a, passes through a charge elimination processor formed by a charge elimination roller 322 and a charge applying section 321, and is conveyed by a conveying roller 324 of the charge elimination apparatus. After that, the sheet is conveyed to the saddle-stitch binding apparatus 200-3b after being subjected to humidifying processing by a humidifying processor 323 to ensure the charge elimination effect.

Next, the saddle-stitch binding apparatus 200-3b will be described. Examples of sheet processing performed by the saddle-stitch binding apparatus 200-3b include saddle-stitch binding, punching, cutting, shift sheet discharging, folding, and stapling. Here, these jobs are referred to as the saddle-stitch binding job. In a case where a saddle-stitch binding job is processed, first, the controller 200 performs control to convey sheets for this job, which have been printed by the printing system 1000, to the saddle-stitch binding apparatus 200-3b and then causes the saddle-stitch binding apparatus 200-3b to execute sheet processing of this job. Then, the controller 200 causes a printed matter of this saddle-stitch binding job, on which the sheet processing has been performed by the saddle-stitch binding apparatus 200-3b, to be held at a sheet discharge destination Z of the saddle-stitch binding apparatus 200-3b. Note that there are a plurality of candidates of the sheet discharge destination Z. With this, the saddle-stitch binding apparatus 200-3b can execute a plurality of types of sheet processing, and the plurality of sheet discharge destinations are used when separating the sheet discharge destination for each sheet processing. In the description of the present embodiment, description of a detailed procedure of conveyance in the saddle-stitch binding job is omitted.

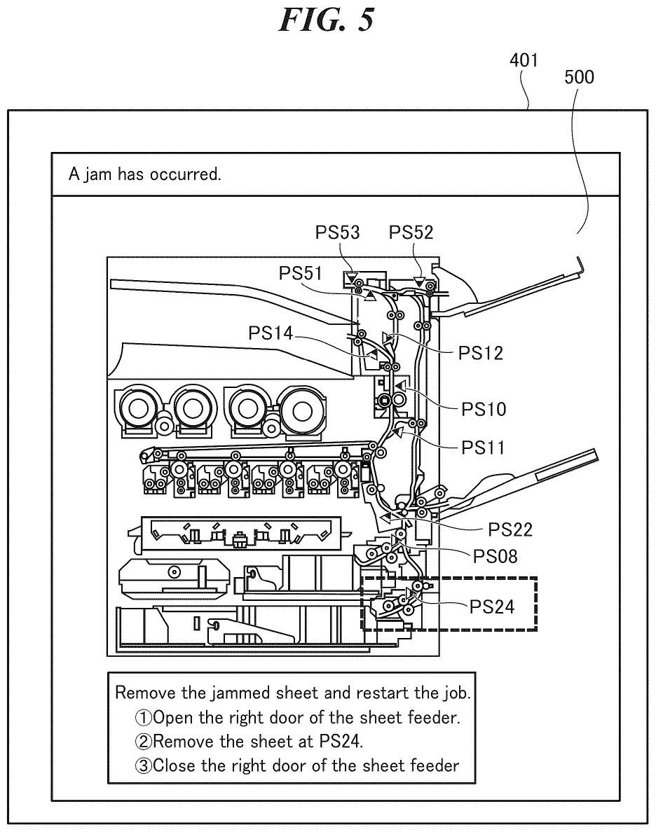

FIG. 5 is an explanatory diagram of an example of a screen displayed on the touch panel section 401 when a jam has occurred in the printing system 1000 according to the embodiments of the present invention. In response to occurrence of a jam, the controller 200 is notified of occurrence of the jam from the printer section 220 or the scanner section 210 and displays a jam processing screen 500 to prompt a user to perform operations following a procedure for eliminating the jammed sheet. Note that although the jam processing screen 500 is displayed e.g. on the touch panel section 401 appearing in FIG. 4, a display section can be separately provided. The example of the jam processing screen 500 shown in FIG. 5 performs display to notify the user (performs guide display) of information indicating that a jam has occurred in the printer section 220, that a position where the jam has occurred is a position of a position sensor (any of PS08, PS 10, PS 11, PS 12, PS 14, PS 22, PS24, PS 51, PS 52, PS 53), a cover to be opened to access this position, and so forth.

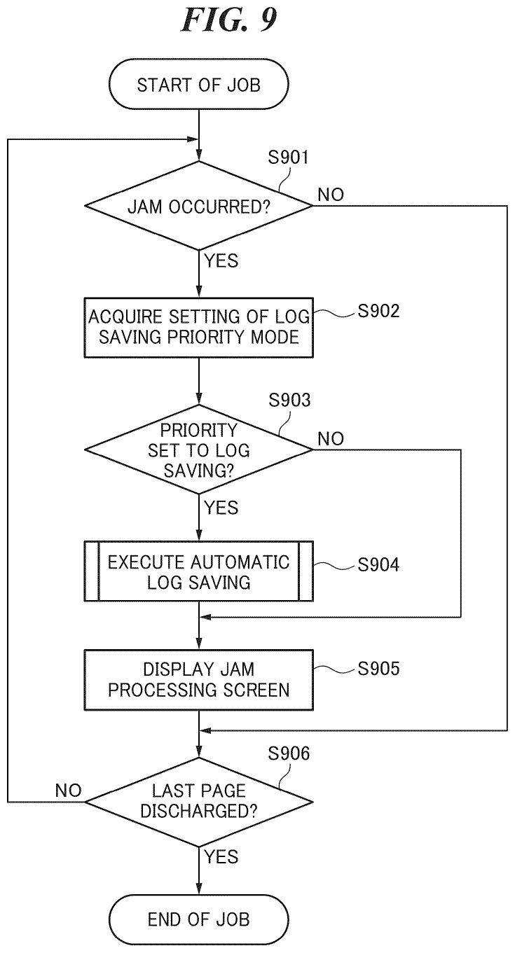

More specifically, FIG. 5 displays a laterally long rectangle indicated by a broken line, surrounding the position where the jam has occurred, so as to enable the user to easily know that the jam has occurred in the vicinity of the position of the sensor PS24. Further, to take measures against the jam which has occurred, a guide for resolving the jam is notified to the user by displaying written language of (1) “Open the right door of the sheet feeder.”, (2) “Remove the sheet in the PS 24 part.”, and (3) “Close the right door of the sheet feeder.”. This guide form is illustrated by way of example. Note that in the present invention, the controller 200 is characterized in that in a case where occurrence of a jam is detected, if setting items (log saving priority-setting sections) 601 and 602, described hereinafter, have been set enabled, the controller 200 executes the following processing: The controller 200 executes a process for automatically saving an operation log of the firmware (software stored e.g. in the ROM 212) by executing a step S904 (automatic log saving process) in FIG. 9, described hereinafter, without displaying the guide shown in FIG. 5. Further, the controller 200 disables reception of a user's operation during execution of this automatic storage log saving process and enables reception of a user's operation by displaying a guide after this automatic log saving process is terminated.

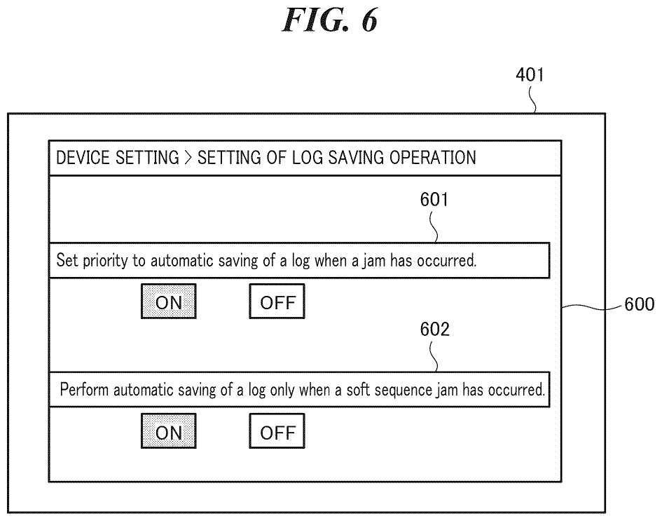

FIG. 6 is an explanatory diagram of a setting screen 600 for setting whether or not to automatically save an operation log of the firmware when a jam has occurred, including setting items. Reference numeral 601 denotes a setting item for setting whether or not to give priority to automatic log saving at a time of occurrence of a jam, and further, reference numeral 602 denotes a setting item for switching, in a case where automatic log saving is executed, whether or not to save a log based on a jam code. Specifically, when an ON button displayed below the setting item 601 is pressed, a mode for giving the priority to automatic log saving at a time of occurrence of a jam is set enabled. On the other hand, when an OFF button displayed below the setting item 601 is pressed, the mode for giving the priority to automatic log saving at a time of occurrence of a jam is set disabled.

Further, when an ON button displayed below the setting item 602 is pressed, a mode for automatically saving a log only at a time of occurrence of a soft sequence jam is set enabled. On the other hand, when an OFF button displayed below the setting item 602 is pressed, the mode for automatically saving a log only at a time of occurrence of a soft sequence jam is set disabled. Note that a jam occurring in the present embodiment includes the following two types, and these are distinguished by jam codes:
(1) The first one is a hard jam which is physically caused by a sheet medium, detected by a sensor in the system, and is notified to the firmware of the printer section 220.
(2) The second one is a soft sequence jam in which there is detected a deviation from the expected sequence of the firmware, for sheet conveyance and image formation using software in the print operation control of the printer section 220.

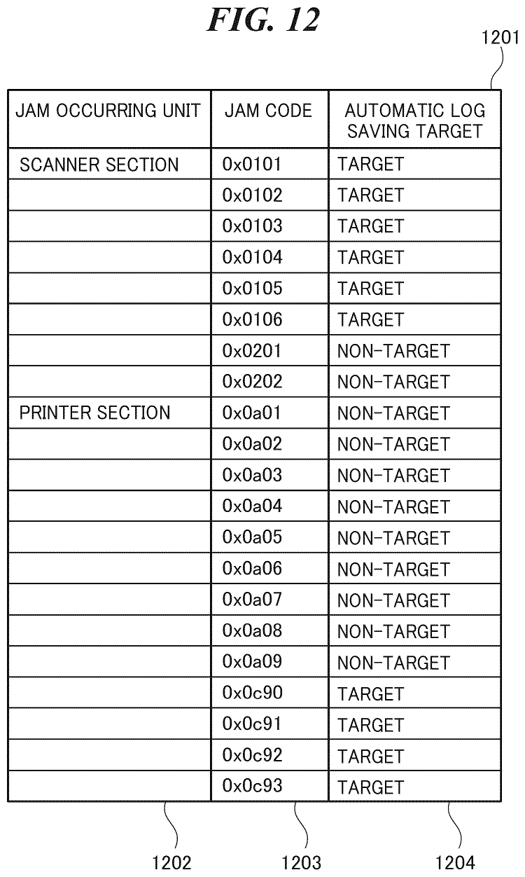

Out of the above-mentioned two types of jams, in the case of (2) the soft sequence jam, control firmware of the printer section 220 can have a malfunction, and the operation log of the printer section 220 is needed. Further, the deviation from the expected sequence of the firmware in the case of (2) includes e.g. a case where the operation is not performed according to the basic processing procedure of the firmware. For example, the CPU 201 of the controller 200 recognizes this fact. As a result, for example, the process for automatically saving an operation log is executed by using occurrence of the next jam as a trigger. FIG. 12 shows an example of definition of the jam codes in the present embodiment.

FIG. 12 shows an automatic log saving definition table 1201 in which a jam occurrence unit 1202, a jam code 1203, and an automatic log saving target 1204 are associated and registered, which is useful for grasping the setting contents set in the setting item 602 appearing in FIG. 6. The jam codes registered as the log saving targets in the automatic log saving target 1204 are jam codes of the soft sequence jam described in the (2). The jam codes defined as the non-log saving targets in the automatic log saving target 1204 are jam codes of the hard jam described in the (1). In the present embodiment, the automatic log saving definition table 1201 is fixedly defined at the time of shipment and stored e.g. in the HDD 204. The automatic log saving definition table 1201 is referred to in a case where the setting in the setting item 601 is set enabled (in a case where the ON button is set) and used for the automatic log saving control. Note that in a case where the priority is not set to automatic saving of the log at a time of occurrence of a jam, the OFF button is selected e.g. by a user. Further, although the example of the two units (the scanner section and the printer section) corresponding to the two types of functions, respectively, has been described with reference to FIG. 12, another function unit can be added to the example shown in FIG. 12.

The example of the setting item 602 appearing in FIG. 6 shows an example of the setting of whether or not to set, as a type of the jam code, only a jam caused by a failure of the firmware, i.e. only (2) the soft sequence jam out of the above-mentioned types of the jam as the automatic log saving target. In the printing system 1000 of the present embodiment, the setting items 601 and 602 are both set to off (disabled) at the time of shipment, and the automatic log saving at a time of occurrence of a jam is started only in a case where the setting items 601 and 602 are set enabled e.g. by a user when required.

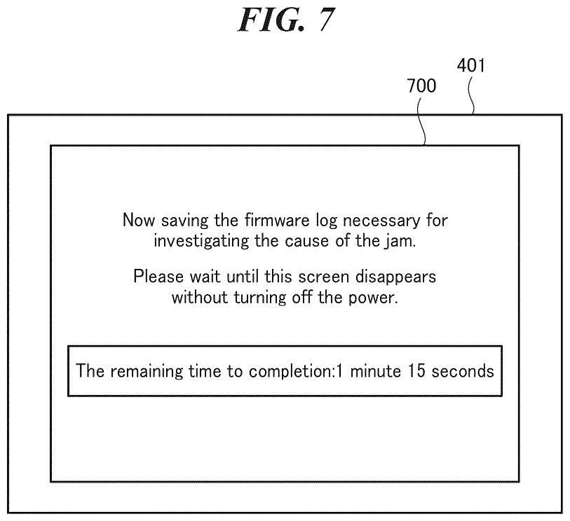

FIG. 6 shows a state in which the setting items 601 and 602 are both set enabled (on). FIG. 7 shows an example of a screen displayed on the console section 240 in a case where a jam related to the setting item 601 and the setting item 602 has occurred. In a case where the setting of automatic log saving at the time of occurrence of a jam is set enabled in the setting item 601, and at the same time the jam code corresponds to the setting item 602, not the jam processing screen shown in FIG. 5, but the screen shown in FIG. 7, denoted by reference numeral 700, is displayed on the touch panel section 401 by the controller 200. This screen notifies the user that the processing for saving a log of the firmware is being performed, and prompts the user to wait until the log saving is completed without performing power off/on. Thus, FIG. 7 shows the example that a predicted time required to complete the log saving is also displayed, i.e. the waiting time for the user is notified, and hence the user-friendly display is realized.

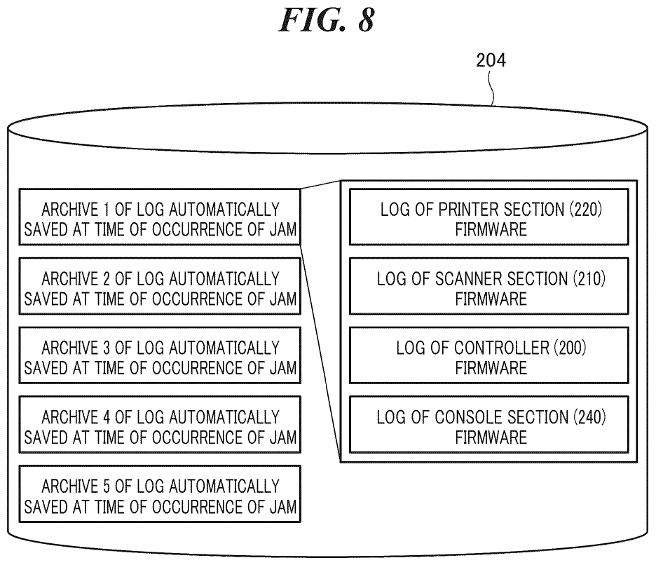

FIG. 8 is an explanatory diagram showing a state in which the operation logs (soft sequence jam) of the firmware items, which are automatically saved, are stored in the HDD 204 (nonvolatile memory). In the present embodiment, the logs for maximum five times of occurrence of jams are compressed and saved in an archive. In a case where a log is to be saved when the sixth and subsequent jams occur, the logs at the recent five times of occurrence of jams are saved by executing rotation processing for deleting the oldest log. In the description of the present embodiment, it is assumed that a jam occurs in the printer section 220 or the scanner section 210, and when a jam has occurred, an operation log of the firmware of the corresponding unit is saved. Therefore, in a case where a jam has occurred in the printer section 220, a log output from the CPU 221 of the printer section 220 is collected and saved in the archive. On the other hand, in a case where a jam has occurred in the scanner section 210, a log output from the CPU 211 of the scanner section 210 is collected and saved in the archive.

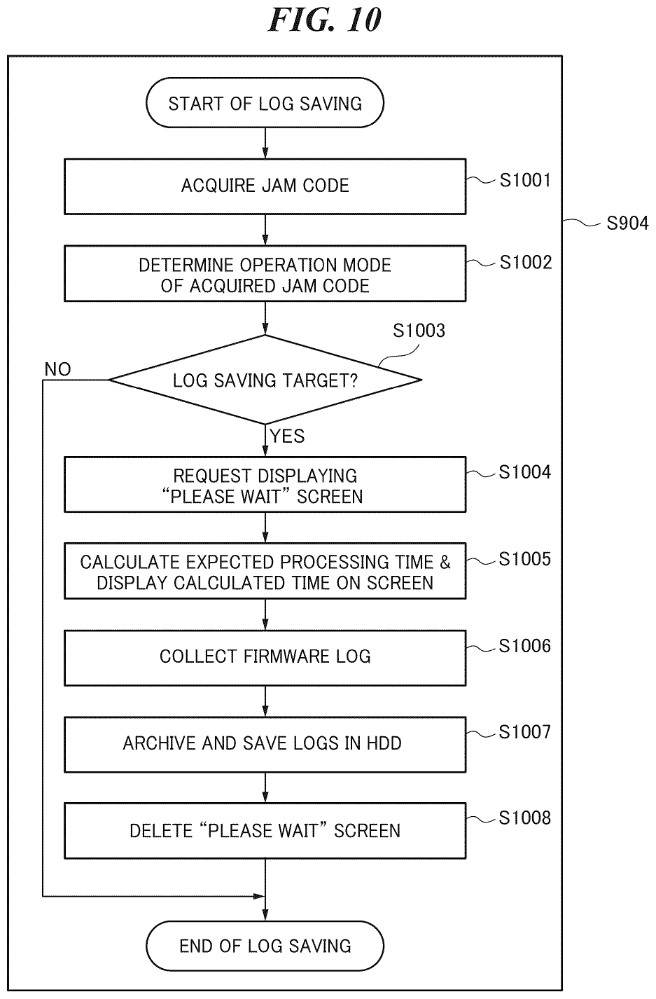

Next, a control process for automatically saving an operation log of the firmware when a jam has occurred will be described with reference to FIGS. 9 and 10. In the following description, it is assumed that the setting item 601 for setting the automatic log saving, appearing in FIG. 6, is set enabled. At the same time, the setting item 602 is also set enabled. Further, the following description of the present embodiment is given by assuming a case in which a jam of a jam code “0x0c92” has occurred in the printer section 220.

Referring to FIG. 9, first, in a step S901, the controller 200 determines whether or not a jam has occurred. If it is determined that a jam has occurred (YES in S901), the process proceeds to a step S902, whereas if not (NO in S901), the process proceeds to a step S906. For example, if it is determined by the controller 200 in the step S901 that a jam has occurred after the start of a copy job performed by the printing system 1000, the controller 200 proceeds to the step S902. In the step S902, the controller 200 refers to the setting of the setting item 601 (enabled or disabled) and proceeds to a step S903.

In the step S903, the controller 200 determines whether or not the log saving priority mode is set. If it is determined by the controller 200 in the step S903 that the log saving priority mode is set to off (disabled), i.e. the priority is not set to the automatic log saving by the setting item 601 (NO in S903), the controller 200 proceeds to a step S905 and displays the normal jam processing screen 500. In the description of the present embodiment, it is assumed that the setting of the setting item 601 is set enabled (YES in S903), in the step S904, the controller executes the automatic log saving process.

Here, the process in the step S904 in FIG. 9 will be described with reference to FIG. 10. First, in a step S1001, the controller 200 acquires a jam code notified from the printer section 220. Next, in a step S1002, the controller 200 refers to the automatic log saving definition table 1201 and, in a step S1003, determines whether or not the acquired jam code is an automatic log saving target. As mentioned above, the jam code is 0x0c92, and by referring to the automatic log saving definition table 1201, a result of the determination of whether or not the acquired jam code is an automatic log saving target indicates the log in question is the storage target (YES in S1003). Therefore, the controller 200 starts the automatic log saving and sends display information to the console section 240 to display the screen 700 on the console section 240 in a step S1004. With this, for example, the above-described screen shown in FIG. 7 is displayed on the console section 240.

In a step S1005, the controller 200 calculates a processing time required to save this log and notifies the console section 240 of the calculated processing time. In response to this, the console section 240 displays a remaining time to completion of saving of the log on the display screen as illustrated in the screen 700 (see FIG. 7). Next, in a step S1006, the controller 200 requests the printer section 220 to transmit the operation log saved in the RAM 223 of the printer section 220. The controller 200 receives the operation log transmitted from the printer section 220 in response to this request (collection of a log of the firmware). Next, in a step S1007, when the operation log has been received from the printer section 220, the controller 200 compresses the received operation logs, and stores the operation logs in the HDD 204 as an archive. Then, in a step S1008, when the operation logs have been saved, the controller 200 notifies the console section 240 of a deletion instruction so as to delete a display screen displayed on the console section 240 in the step S1004, on which written language, such as “Please wait”, has been written. With this, the display screen shown in FIG. 7 is deleted from the console section 240.

With this processing, the process in the step S904 for saving an operation log of the firmware when a jam has occurred is completed, and the description given with reference to FIG. 9 is resumed. Since the automatic log saving (step S904) is completed, in the step S905, the controller 200 causes the console section 240 to display the jam processing screen 500 so as to prompt the user to perform jam processing. The user completes the jam processing and restarts the job which has been interrupted due to occurrence of the jam. Then, in the step S906, the controller 200 continues the job processing until the last sheet is printed out while determining whether or not the last sheet to be printed has been printed out. That is, if it is determined that the last sheet has not been printed out (NO in S906), the controller 200 returns to the step S901 and repeatedly continues the series of processing operations. On the other hand, if it is determined by the controller 200 that the last sheet has been printed out (YES in S906), the control process in FIGS. 9 including the automatic log saving process shown in FIG. 10 is terminated.

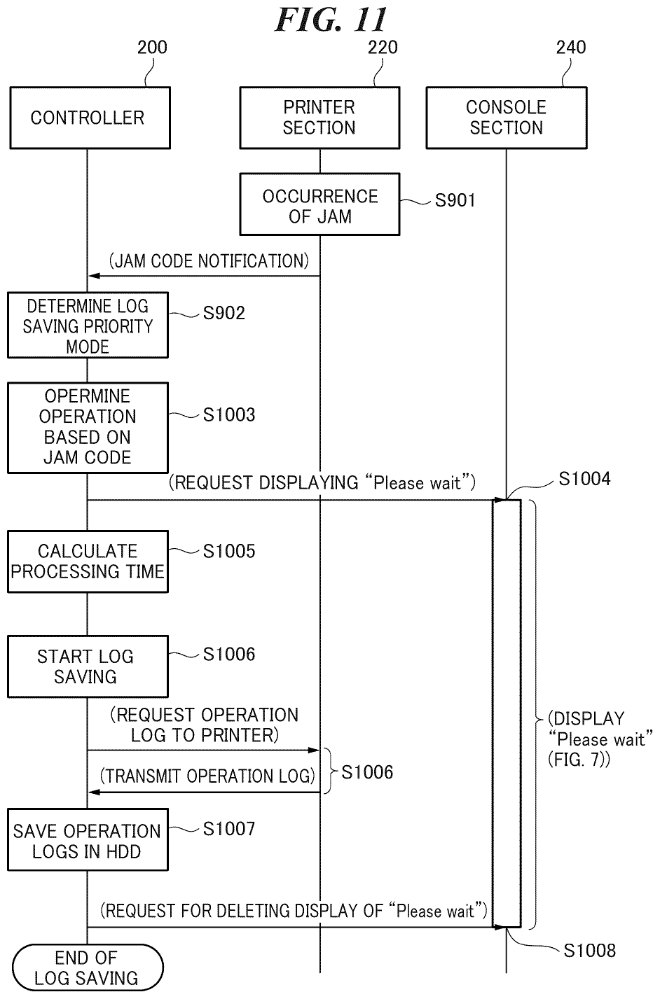

Next, for ease of understanding the first embodiment of the present invention, operations for storing an operation log of the firmware when a jam has occurred will be described with reference to FIG. 11 showing a sequence diagram corresponding to the control process in FIG. 9 including the automatic log saving process in FIG. 10. First, in a case where a jam has occurred in the printer section 220 (S901), the CPU 221 of the printer section 220 notifies the controller 200 of the jam code (0x0c92) of the jam which has occurred. The controller 200 refers to a setting in the setting item 601 in the step S902 and then determines in the step S1003 whether or not the notified jam code is an automatic log saving target.

If it is determined that the notified jam code is the automatic log saving target, the controller 200 displays the screen 700 on the console section 240 in the step S1004. Then, in the step S1005, the controller 200 calculates a processing time required to save this log and notifies the console section 240 of the calculated processing time to display the calculation result and so forth. Next, in the step S1006, the controller 200 starts the log saving process. Specifically, the controller 200 requests the printer section 220 to transmit the operation log saved in the RAM 223 of the printer section 220. The controller 200 receives the operation log transmitted from the printer section 220 in response to this request. Next, in the step S1007, when reception of the operation log from the printer section 220 is completed, the controller 200 compresses the received operation logs, and stores the operation logs in the HDD 204 as an archive. Finally, in the step S1008, when the operation logs have been saved, the controller 200 notifies the console section 240 of a deletion instruction so as to delete a display screen shown in FIG. 7, which is displayed on the console section 240 in the step S1004. Thus, the display screen shown in FIG. 7 is deleted from the console section 240.

Here, the operation log of the firmware at the time of occurrence of the jam, which has been saved in the HDD 204, is finally transferred from the printing system 1000 to the outside to analyze the cause of the jam by the vendor of the apparatus. In the present embodiment, the operation log saved in the HDD 204 of the controller 200 is collected from an external server, not shown, via the network 101. The form of automatically collecting the operation log is not limited to this. For example, the operation log can be collected by using the external I/F included in the printing system 1000 via the network 101.

Further, if the printing system 1000 is equipped with a USB terminal, the operation log can be collected by attaching a USB memory. Note that although in the present embodiment, occurrence of a jam in the printer section 220 has been described, for example, even in a case where a jam occurs in the scanner section 210, the same flow of processing operations is performed. Therefore, description in the case where a jam occurs in the scanner section 210 is omitted.

Next, a second embodiment of the present invention will be described. In the above-described first embodiment, the screen for rejecting reception of any operation of the printing system 1000 during the operation of automatically saving a log is displayed on the console section 240. However, the second embodiment is characterized in that an operation of a unit which can operate as a normal function is available.

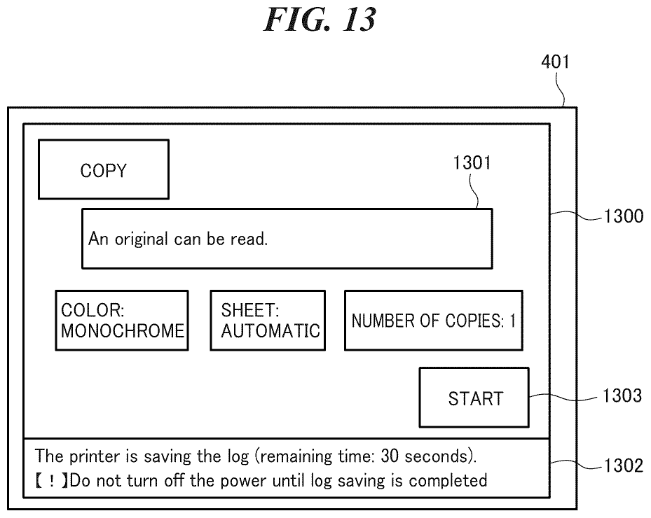

FIG. 13 shows a screen display 1300 of the copy function, which is displayed during the operation of collecting and saving an operation log of the firmware of the printer section 220 when a jam has occurred in the printer section 220. On the touch panel section 401, a start button 1303 and a message 1301 concerning the copy function are displayed. Then, on a status line 1302 in the lower part of the screen, a message to the effect that the printer section 220 is collecting an operation log, and hence the user cannot use the printer section 220 is displayed. Besides this message, the screen shows a state in which the scanner section 210 which is not related to collection of the operation log can operate. Specifically, a message “The printer is saving the log (remaining time: 30 (sec)). Do not turn off the power until the saving is completed.” is displayed to attract user's attention.

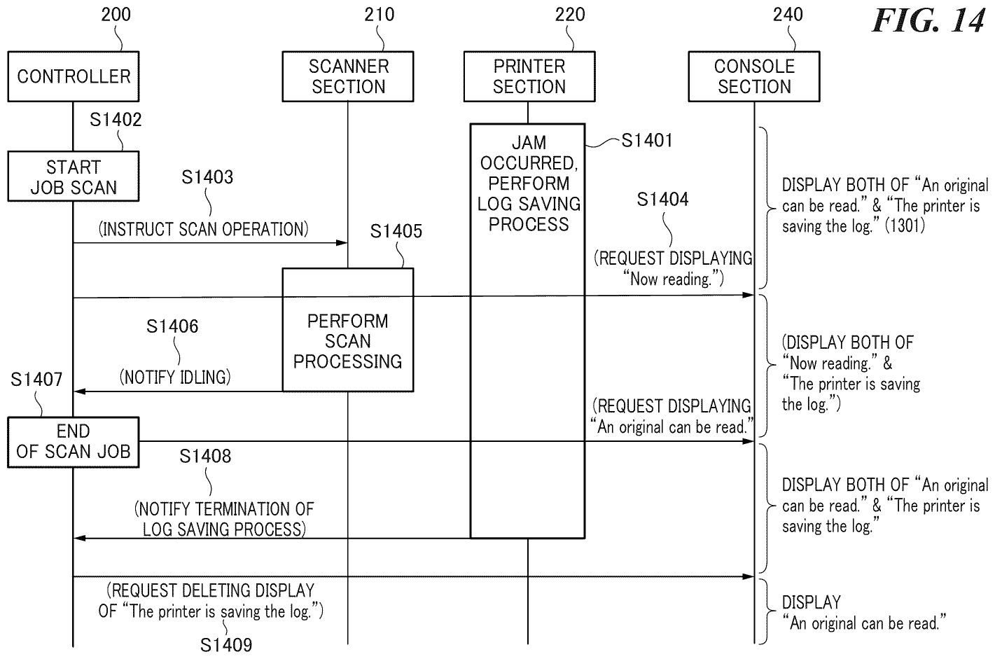

The operation of the scanner section 210 which can operate in this state will be described with reference to FIG. 14. After a job is started, a jam occurs in the printer section 220, and a log of the firmware of the printer section 220 is being saved (S1401). Note that a series of the log saving process executed in the step S1401 is the same as in the sequence in FIG. 11 but is different in the contents of the display request notified to the console section 240. Since the scanner section 210 can normally operate in this state, the screen of the console section 240 performs the display described with reference to FIG. 13 to notify the user that the scan operation is available.

In a step S1402, when an operation of starting a scan job (scan job start) is performed by the user, the controller 200 instructs the scanner section 210 to perform the scan operation (S1403). Upon receipt of this instruction, the scanner section 210 starts the scan operation (S1405).

Next, the controller 200 requests the console section 240 to display a message “Now reading.” indicating that the scanner is operating, and the display in the message 1301 (see FIG. 13) on the console section 240 is changed from “An original can be read.” to “Now reading.” (S1404).

By executing the step S1404, since the printer section 220 is continuing the log saving process, a message “The printer is saving the log,” is displayed on the status line 1302 (see FIG. 13). Then, in a step S1406, when the scan processing is terminated, the scanner section 210 notifies termination of scanning to the controller 200 (idle notification), and the controller 200 grasps termination of the scan job (S1407).

Next, in the step S1407, simultaneously when the scan job is terminated, the controller 200 notifies a request for changing the display to a display notifying the user that the scanner section 210 has returned to the idle state and that the next operation can be received, to the console section 240. With this, the display of a status indicating “Reading is available.” is requested, and the console section 240 displays “Reading is available.” as a main status and continuously displays “The printer is saving the log.” on the status line (S1407).

Then, when the log saving process performed by the printer section 220 is terminated, a log saving termination notification is sent from the printer section 220 to the controller 200 (S1408). In response to this, the controller 200 notifies a request for deleting the display of “The printer is saving the log.” to the console section 240 (S1409). In the step S1409, the scanner section 210 and the printer section 220 are both in the idle state and can receive the next job. Therefore, the console section 240 displays a message “Copying is available.” indicating the scanner section 210 and the printer section 220 are both usable, and the printing system 1000 returns to a state waiting for a user's operation.

As described above, even when the printer section 220 is executing the log saving process, an operation of the scanner section 210 (unit) which can operate as the normal function is normally available, which provides the convenience to a user. Further, in a case where the same jam code is repeatedly notified e.g. from the printer section (the same unit) 220, the controller 200 can be configured not to start the process for automatically saving an operation log in response to the notification of the jam code, which is sent after a predetermined number of times (such as three times or more).

Further, the firmware, an operation log of which is to be collected and analyzed by the vendor of the apparatus, is not limited to one stored in the ROM, but for example, circuit information or the like, which is used by a programmable logic device (PLD), is also included in the firmware. Further, a transmission section can be provided which is configured to transmit collected operation logs saved in the HDD 204 to the PC 102 or another information processing apparatus, not shown, via the network 101 at a predetermined timing. This predetermined timing includes various timings, and for example, the operation log can be transmitted whenever the automatic log saving process is completed, or at every predetermined time period (such as every week), or when the number of times of occurrence of a jam within a predetermined time period exceeds a predetermined threshold value by way of example, but the predetermined timing is set not limited to these.

Further, for execution of analysis of a log, it is preferable that the above-mentioned other information processing apparatus is installed in the vendor of the apparatus. Further, as described above, the process according to the present invention can be executed when the controller 200 recognizes deviation from the expected sequence due to occurrence of a soft sequence jam, but the process can be performed in another form as follows: The controller 200 can execute the automatic operation log saving process at a predetermined timing. As this predetermined timing, the automatic operation log saving process can be executed in a case where the number of occurrence of a jam within a predetermined time period is abnormally large (such as a multiple of a predetermined threshold value), or in a case where the automatic operation log saving process is executed whenever the predetermined time period elapses, and if a jam occurs in future at a timing nearest to a timing at which the predetermined time period elapses this time. In doing this, with respect to this jam, it is not necessary to distinguish the hard jam or the soft sequence jam. Not only these, other various timings are considered, but the automatic operation log saving process according to the present invention can be executed not only at this predetermined timing.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-031994 filed Mar. 4, 2024, which is hereby incorporated by reference herein in its entirety.

What is claimed is:

1. A printing system including a jam detection section that detects occurrence of a jam as a state in which a sheet is jammed, a guide display section that displays a guide of a procedure for removing a sheet in response to occurrence of the detected jam, and a plurality of units associated with a plurality of types of functions, respectively, comprising:
a log saving section that automatically saves an operation log of firmware that controls one unit;
a log saving priority-setting section for setting a priority of operation of the log saving section when a jam has occurred; and
a controller that causes, when occurrence of a jam is detected by the jam detection section in a case where the priority of operation of the log saving section has been set by the log saving priority-setting section, the log saving section to execute an automatic saving process for automatically saving an operation log of firmware, and a screen to be displayed on a display section, for prompting a user to wait until the automatic saving process is terminated.

2. The printing system according to claim 1, wherein the controller further causes, when occurrence of a jam is detected by the jam detection section in a case where the priority of operation of the log saving section has been set by the log saving priority-setting section, the log saving section to execute the automatic saving process for automatically saving the operation log of firmware without displaying the guide, and disables reception of a user's operation during execution of the automatic saving process but enables reception of a user's operation by displaying the guide after the automatic saving process is terminated.

3. The printing system according to claim 1, wherein a unit in which a jam has occurred generates a jam code defining automatic log saving target information indicating whether or not a log is to be saved with respect to the jam which has occurred and notifies the generated jam code to the controller, and
wherein the controller further determines whether or not to execute the automatic saving process based on a type of the notified jam code.

4. The printing system according to claim 1, wherein the controller further disables reception of a user's operation with respect to a unit for which a jam is set as the log saving target, during the operation of the automatic saving process, but enables reception of a user's operation with respect to a unit other than the above-mentioned unit.

5. The printing system according to claim 1, wherein the controller further calculates a processing time required to perform the automatic saving process this time and displays the calculated processing time on the display section.

6. The printing system according to claim 1, wherein in a case where the same jam code is repeatedly notified from the same unit, the controller does not start the automatic saving process in response to notification of the jam code, which is executed after a plurality of predetermined number of times of notification.

7. The printing system according to claim 1, wherein the controller saves an operation log collected by executing the automatic saving process in a nonvolatile memory.

8. The printing system according to claim 7, wherein the controller compresses operation logs most recently collected over a plurality of times by executing the automatic saving process and collectively stores the operation logs in a nonvolatile memory, and deletes an older operation log than the operation logs most recently stored over the plurality of times.

9. The printing system according to claim 7, further comprising a transmission section that transmits the collected operation logs to an information processing apparatus installed in an apparatus vendor at a predetermined timing via a network.

10. The printing system according to claim 1, wherein the plurality of units include a scanner section that performs scanning and a printer section that performs printing.

11. A method of controlling a printing system including a jam detection section that detects occurrence of a jam as a state in which a sheet is jammed, a guide display section that displays a guide of a procedure for removing a sheet in response to occurrence of the detected jam, and a plurality of units associated with a plurality of types of functions, respectively, comprising:
automatically saving an operation log of firmware that controls one unit;
setting a priority of saving the operation log when a jam has occurred; and
causing, when occurrence of a jam is detected by the jam detection section in a case where the priority of saving the operation log has been set, an automatic saving process to be executed for automatically saving an operation log of firmware, and a screen to be displayed on a display section, for prompting a user to wait until the automatic saving process is terminated.

12. A non-transitory computer-readable storage medium storing a program for causing a computer to execute a method of controlling a printing system including a jam detection section that detects occurrence of a jam as a state in which a sheet is jammed, a guide display section that displays a guide of a procedure for removing a sheet in response to occurrence of the detected jam, and a plurality of units associated with a plurality of types of functions, respectively, wherein the method comprises:
automatically saving an operation log of firmware that controls one unit;
setting a priority of saving the operation log when a jam has occurred; and
causing, when occurrence of a jam is detected by the jam detection section in a case where the priority of saving the operation log has been set, an automatic saving process to be executed for automatically saving an operation log of firmware, and a screen to be displayed on a display section, for prompting a user to wait until the automatic saving process is terminated.
